(19) United States
(12) Patent Application Publication
(10) Pub. No.: US 2010/0207831 A1
(43) Pub. Date: Aug. 19, 2010

(54) Loop Dipole Antenna Module

(76) Inventor: Huei-chi Wu, Jhongli City (TW)

Correspondence Address: Jackson Intellectual Property Group PLLC, 106 Starvale Lane, Shipman, VA, 22971, US

(21) Appl. No.: 12/372,835

(22) Filed: Feb. 18, 2009

(51) Int. Cl. H01Q 11/12; H01Q 7/00

(52) U.S. Cl. 343/742

(57) ABSTRACT

The present invention discloses an antenna module including two double-ring antennas installed at an angle of 90° with respect to a surface of the panel which is comprised of a printed circuit board, two feedback nodes disposed on the panel and at positions corresponding to the two double-ring antennas respectively, and a metal reflecting plate installed on a backside of the panel. The whole antenna module can receive vertical and horizontal signals on the surface of the metal reflecting plate by using the double-ring antennas with the two feedback nodes respectively to achieve the expected bandwidth and the required bidipolarization effects and accomplish a better gain.

### BACKGROUND OF THE INVENTION

(a) Field of the Invention

The present invention generally relates to a loop antenna module, and more particularly to a loop dipole antenna module having the advantages of a simple structure and a low cost, and being capable of achieving the required bandwidth and the expected bidipolarization effect.

(b) Description of the Related Art

As mobile communications business becomes one of the most popular wireless applications in the market, the mobile communications WiMAX standard such as the IEEE 802.11e is formally announced, and the WiMAX mobile version becomes the latest new-generation mobile communication technology, in addition to the third generation (3G) mobile communication technology. Regardless of the mobile communication technology adopted by the present mobile communications devices, the basic requirement for general users includes the capability of having a connecting state anywhere and anytime.

Although the design of an antenna structure and the capability of receiving signals have direct impacts on the communication quality of a wireless communications product, the appearance of a mobile communication device, a printed circuit board (PCB), a structure and an antenna are related closely with each other and limited to the space of the mobile communication device, in order to providing the expected performance of the antenna. With reference to FIG. 1 for a perspective view of a conventional loop antenna, the loop antenna includes a loop antenna 2 installed on a panel of a reflecting plate 1 for providing the functions of transmitting and receiving radiations of a specific single frequency band.

Since the aforementioned conventional loop antenna has the functions of transmitting and receiving radiations of a specific single frequency band only and the radiation transmission/receiving gain is low, therefore a wireless communications device equipped with a loop antenna of a single frequency band can be applied for the specific single frequency band only, and the range and distance of its applications are restricted substantially. On the other hand, the conventional loop antenna with a single frequency band is insufficient and inconvenient to users who travel frequently and require different frequency bands and transmission/receiving distance.

In addition, a plurality of sheets are assembled on the reflecting plate 1 to form the conventional loop antenna 2, and such arrangement not only incurs a higher manufacturing cost, but also requires a specific association between the loop antenna 2 and the reflecting plate 1, and thus it is necessary to position a feedback node on the reflecting plate 1 to fit different applications of the users. Obviously, the applicability of the conventional loop antenna 2 is relatively low.

### SUMMARY OF THE INVENTION

Therefore, it is a primary objective of the present invention to provide a loop dipole antenna module capable of accomplishing the required bandwidth and the expected bidipolarization effect.

To achieve the foregoing objective, the present invention provides a loop dipole antenna module, wherein two double-ring antennas are installed perpendicularly (with an angle of 90°) with a panel composed of a printed circuit board, and each double-ring antenna has two circular-ring conductors installed adjacently to each other, and the whole loop dipole antenna module directly installs two feedback nodes on the panel and at positions corresponding to the two double-ring antennas. In addition, the backside of the panel has a metal reflecting plate, and a specific interval is maintained between the metal reflecting plate and the panel.

When use, the whole loop dipole antenna module receives vertical and horizontal signals on a surface of the metal reflecting plate by using the double-ring antenna with the two feedback nodes to achieve the required bandwidth and the expected bidipolarization effect and accomplish a better gain.

### BRIEF DESCRIPTION OF THE DRAWINGS

FIG. 1 is a perspective view of a conventional loop antenna;

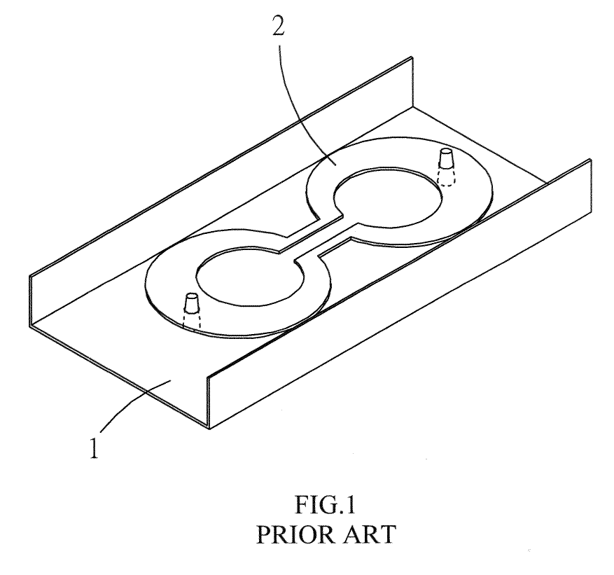

FIG. 2 is a perspective view of a loop dipole antenna module in accordance with a first preferred embodiment of the present invention;

FIG. 3 is a graph showing the reflection loss of an electrical test in accordance with a preferred embodiment of the present invention;

FIG. 4 is a graph showing the gain in accordance with a preferred embodiment of the present invention; and

FIG. 5 is a perspective view of a loop dipole antenna module in accordance with a second preferred embodiment of the present invention.

### DETAILED DESCRIPTION OF THE PREFERRED EMBODIMENTS

The present invention will become apparent from the description of a preferred embodiment of a display device with a complex backlight module and the illustration of related drawings. It is noteworthy to point out that same elements mentioned in the preferred embodiment are numbered with the same numerals respectively.

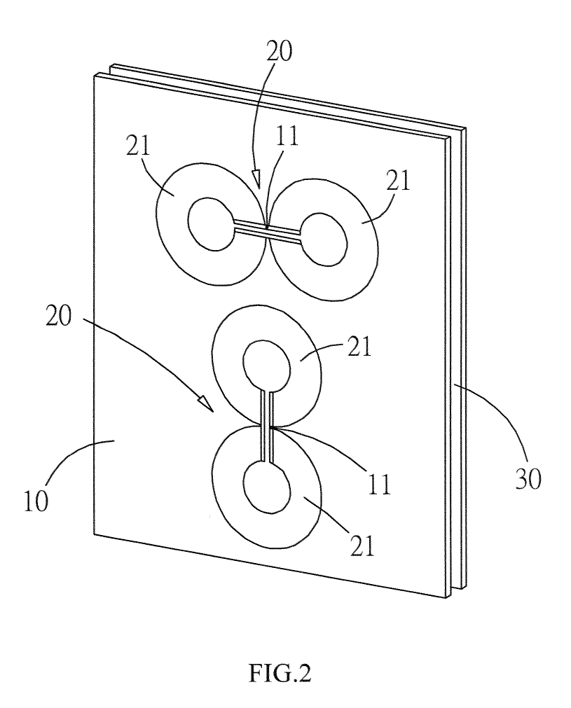

With reference to FIG. 2 for a loop dipole antenna module of the present invention, the loop dipole antenna module comprises a panel 10, two double-ring antennas 20, and a metal reflecting plate 30.

The two double-ring antennas 20 are installed at an angle of 90° with respect to a surface of the panel 10, and each double-ring antenna 20 includes two circular-ring conductors 21 installed adjacently to each other. In the preferred embodiment, the panel 10 is comprised of a printed circuit board, and the two double-ring antennas 20 are comprised of a printed circuit on the panel 10, so that a single-sided printed circuit board can be used in the manufacturing procedure to complete manufacturing the panel 10 and the two double-ring antennas 20, and the two feedback nodes 11 can be set directly on the panel 10 and at positions corresponding to the two double-ring antennas 20 respectively to achieve the effects of simplifying the structure and lowering the manufacturing and assembling costs.

The metal reflecting plate 30 is installed on the backside of the panel 10 and a specific interval is maintained between the metal reflecting plate 30 and the panel 10, so that the whole loop dipole antenna module can use the double-ring antennas 20 with the two feedback nodes 11 of the panel 10 to receive vertical and horizontal signals on a surface of the metal reflecting plate 30, so as to achieve the required bandwidth and the expected bidipolarization effect and accomplish a better gain.

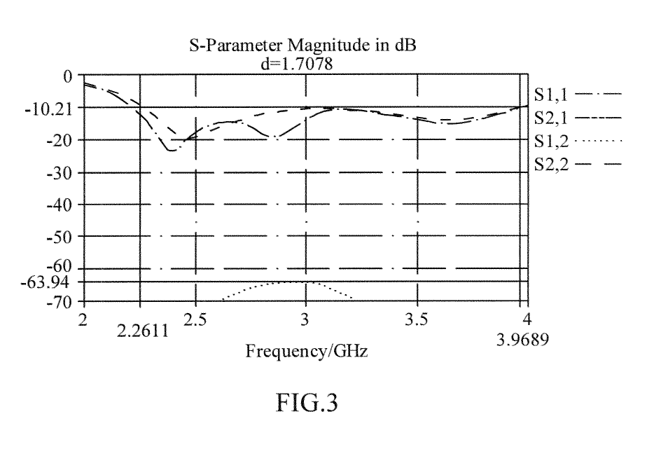

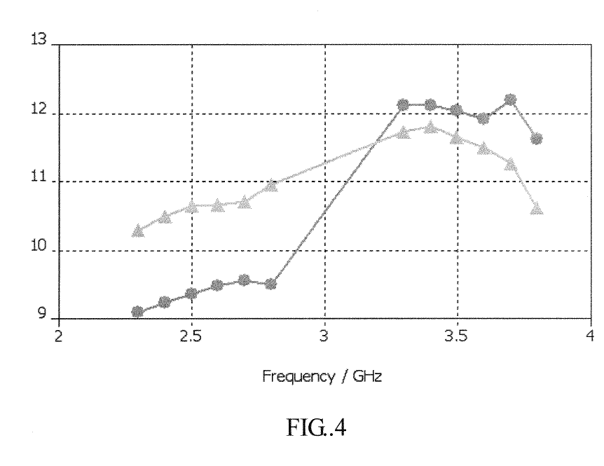

With reference to FIG. 3 for a graph showing the reflection loss of an electrical test in accordance with a preferred embodiment of the present invention and FIG. 4 for a graph showing the gain of a test conducted within a frequency band range from 2.3 GHz to 3.8 GHz in accordance with a preferred embodiment of the present invention, the results show that the electrical properties of the loop dipole antenna module can receive signals with a frequency band covering a range of 2.3˜3.8 GHz effectively, and such frequency band is applicable for almost all WIMAX systems in the world.

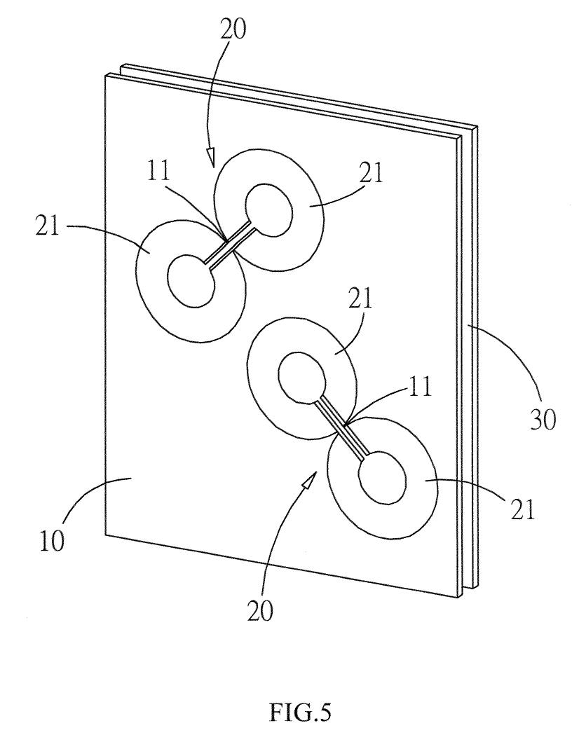

It is noteworthy to point out that the loop dipole antenna module of the invention as shown in FIG. 2 adopts two double-ring antennas 20 installed in a vertical direction and a horizontal direction with respect to a vertical line of a surface of the metal reflecting plate 30 respectively to achieve the required bandwidth and the expected bidipolarization effect. Of course, the two double-ring antennas 20 can be at an angle of positive 45° and an angle of negative 45° with respective to a vertical line of a surface of the metal reflecting plate 30 respectively as shown in FIG. 5 to achieve the best effect of receiving horizontal signals as well as vertical signals, so as to achieve the best performance of the antenna.

In summation of the description above, the present invention provides a preferred feasible structure of a loop dipole antenna module to overcome the shortcomings of the prior art, and complies with the requirements of patent application and thus is duly filed for patent application.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

I claim:

1. A loop dipole antenna module, comprising:
a panel;
two double-ring antennas, installed at an angle of 90° with respect to a surface of the panel, and each double-ring antenna including two circular-ring conductors;
a metal reflecting plate, installed on a backside of the panel, and maintained at a specific interval from the panel; and
two feedback nodes, disposed on the panel and at positions corresponding to the two double-ring antennas respectively.

2. The loop dipole antenna module of claim 1, wherein the panel is comprised of a printed circuit board.

3. The loop dipole antenna module of claim 1, wherein the panel is comprised of a printed circuit board, and the two double-ring antennas are comprised of a printed circuit on the panel.

4. The loop dipole antenna module of claim 1, wherein the two circular-ring conductors of each double-ring antenna are installed adjacently to each other.

5. The loop dipole antenna module of claim 1, wherein the two double-ring antennas are installed in a vertical direction and a horizontal direction with respect to a vertical line of the surface of the metal reflecting plate respectively.

6. The loop dipole antenna module of claim 1, wherein the two double-ring antennas are installed at an angle of positive 45° and an angle of negative 45° with respective to a vertical line of a surface of the metal reflecting plate respectively.
